(19) United States
(12) Patent Application Publication
(10) Pub. No.: US 2008/0004408 A1
(43) Pub. Date: Jan. 3, 2008

(54) Method for the Continuous Production of Crosslinked Particulate Gel-Type Polymers

(75) Inventors: Uwe Stueven, Bad Soden (DE); Matthias Weismantel, Jossgrund (DE); Rudiger Funk, Niedernhausen (DE); Annemarie Hillebrecht, Mannheim (DE); Dominicus van Esbroeck, Wouse Plantage (NL); Karl J. Possemiers, Brasschaat (BE); Ronny De Kaey, Vremde (NL)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Basf Aktiengesellschaft, Ludwigshafen (DE)

(21) Appl. No.: 11/662,824

(22) PCT Filed: Sep. 21, 2005
(86) PCT No.: PCT/EP05/10188

§ 371 Date: Mar. 14, 2007

(30) Foreign Application Priority Data
Sep. 28, 2004 (DE) 102004047528.8
Oct. 22, 2004 (DE) 102004051646.4
May 17, 2005 (DE) 102005023325.2

(51) Int. Cl. C08F 2/01

(52) U.S. Cl. 526/88

(57) ABSTRACT

Disclosed is a method for the continuous production of crosslinked, particulate, gel-type polymers by copolymerizing a) water-soluble, monoethylenically unsaturated monomers, b) 0.001 to 5 molar percent of monomers containing at least two polymerizable groups, the percentage being relative to the monomers (a), in a mixer. The substances that are added at the beginning of the kneader are conveyed in an axial direction towards the end of the mixer. The inventive method is characterized in that at least one of the following conditions is met: i) the filling level in the kneader mixer is at least 71 percent; ii) the water-soluble, monoethylenically unsaturated monomers contain up to 150 ppm of a semicyclic ether of a hydroquinone; iii) the temperature in the polymerization zone exceeds 65° C.; iv) the kneader has a remixing rate of less than 0.33.

The present invention relates to a process for continuous production of crosslinked fine particles of addition-polymer gel in a kneader.

Further embodiments of the present invention are apparent from the claims, the description part and the examples. It will be appreciated that the hereinbefore identified and the hereinafter still to be more particularly described features of the subject matter of the present invention are utilizable not only in the particular combination indicated but also in other combinations without leaving the realm of the present invention.

Crosslinked fine particles of addition-polymer gel (superabsorbents for example) are produced using kneader polymerization as well as belt and batch polymerization.

Prior art kneader processes have disadvantages, an example being the formation of comparatively large agglomerates of superabsorbent in the continuous large-scale industrial production process. These agglomerates have to be separated out and lead to increased production costs.

DE 34 32 690 discloses a process for continuous production of crosslinked addition polymers by polymerizing water-soluble monomers in the presence of a crosslinker and of initiators in a tank equipped with a plurality of parallel rotary stirrer shafts fitted with stirrer blades. The polymerization is carried out continuously in a two-arm kneader or, for example, in a three-shaft kneader. This type of reactor gives rise to such pronounced backmixing that the monomer solution is applied to the finely divided watery gel polymer and the polymerization of the monomer takes place on the surface of the polymer gel. The finely divided addition polymer gels producible in this way have a relatively high residual monomer content.

EP 223 063 teaches a process for continuous production of crosslinked fine particles of addition polymer gel in a single-screw cylindrical mixer whose mixing segments cause materials to be conveyed from the upstream to the downstream end of the cylindrical mixer. The acrylic acid used is of commercial grade (MEHQ content: 200 ppm) and the fill level in the reactor is indeterminate.

List, a manufacturer of kneading reactors featuring backmixing, recommends a fill level of not more than 70%, including especially for the continuous polymerization of superabsorbents (cav 6/2003 page 44/45). It is also recommended there that kneading reactors for the continuous polymerization of SAP be operated with backmixing. This recommendation is followed by leading superabsorbent producers.

WO 01/38402 discloses a process for continuous production of superabsorbents. The acrylic acid used has an MEHQ content of 180-200 ppm. The product of residence time and reaction solution feed is 150 kg or less in all examples, for a given reaction volume of 300 liters.

WO 03/22896 discloses a process for continuous production of superabsorbents in kneaders. The acrylic acid used has an MEHQ content of commercial 200 ppm. The product of residence time and reaction solution feed is 6.2 kg or less in the examples, for a given reaction volume of 30.9 liters.

WO 03/051940 discloses a process for producing superabsorbents having a low MEHQ content. Superabsorbents are produced batchwise either through adiabatic polymerization or in a kneader. The processes disclosed, and according to the invention, in WO 03/051940 have a peak temperature time during the polymerization of 7 minutes to 24 minutes and a residual monomer content of 190 to 620 ppm.

The present invention therefore has for its object, among others, to provide a simple process having better production costs.

We have found that this object is achieved, surprisingly, by a process which overcomes the disadvantages of the prior art.

This is a process for continuous production of crosslinked fine particles of addition-polymer gel by copolymerizing
a) water-soluble monoethylenically unsaturated monomers,
b) from 0.001 to 5 mol % based on the monomers (a) of monomers comprising at least two polymerizable groups,
in a kneader which conveys materials introduced at an upstream end of the kneader in an axial direction toward a downstream end of the mixer, wherein at least one of the following conditions is fulfilled:
i) fill level in mixing kneader not less than 71%, or
ii) the water-soluble monoethylenically unsaturated monomers comprise up to 150 ppm of a half-ether of a hydroquinone,
iii) the temperature in the polymerization zone is more than 65° C.,
iv) the kneader has a backmixing ratio of less than 0.33.

The reference to fine particles is preferably to be understood in this present invention's process as meaning that agglomerates having a longest diameter of >10 cm comprise less than 15%, preferably less than 12%, more preferably less than 10% or even less than 7%, even more preferably less than 5% or even 4%, yet even more preferably less, than 3% or even less than 2% and especially less than 1% and even less than 0.5% (all dry weight based on total mass of dried gel).

Alternatively, the reference to fine particles is likewise preferably to be understood in this present invention's process as meaning that agglomerates having a longest diameter of >5 cm appear at less than 30 agglomerates per hour,, preferably less than 10, more preferably less than 5, even more preferably less than 3, especially less than 2 or even less than 1 agglomerate per hour of operation.

It is preferable for the abovementioned combined limits on agglomerates (>10 mm and >5 cm) to apply in the process of the present invention.

Crosslinked addition polymer gels are described for example in the monograph Modern Superabsorbent Polymer Technology, F. L. Buchholz and A. T. Graham, Wiley-VCH, 1998, or in Ullmann's Encyclopedia of Industrial Chemistry, 6th edition, volume 35, pages 73 to 103.

The crosslinked fine particles of addition polymer gels typically have a centrifuge retention capacity of not less than 15 g/g, preferably not less than 20 g/g and more preferably not less than 25 g/g. Centrifuge retention capacity is determined by the eponymous recommended test method No. 441.2-02 of EDANA (European Disposables and Nonwovens Association).

The water-absorbing polymers typically have an absorption under pressure 0.7 psi of not less than 15 g/g, preferably not less than 20 g/g and more preferably not less than 25 g/g. Absorption under pressure is determined by the eponymous recommended test method No. 442.2-02 of EDANA (European Disposables and Nonwovens Association).

Water-absorbing polymers may be produced by reacting water-soluble monoethylenically unsaturated monomers in the presence of crosslinkers to form a base polymer. The polymerization may also be carried out in the presence of a suitable grafting base, as described in U.S. Pat. No. 5,041,496. The reaction may be carried out for example as a free-radical solution polymerization or an inverse suspension polymerization. Free-radical solution polymerization is preferred.

Useful monomers include for example ethylenically unsaturated carboxylic acids, such as acrylic acid, methacrylic acid, maleic acid, fumaric acid and itaconic acid, or their derivatives, such as acrylamide, methacrylamide, acrylic esters and methacrylic esters. Acrylic acid and methacrylic acid are particularly preferred monomers.

The monomers, in particular acrylic acid, comprise up to 150 ppm (weight) of half ether of a hydroquinone in one alternative according to the present invention.

Half ether of a hydroquinone is generally to be understood as meaning compounds of the following formula: 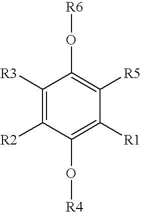
where R¹, R², R³ and R5 are independently H or an alkyl radical having 1 to 20 carbon atoms, R⁴ is H or acyl having 1-20 carbon atoms and R6 is a hydrocarbyl radical having up to 20 carbon atoms, although R5 and R6 may also combine to form a carbocycle.

Preferred half ethers are MEHQ (monomethyl ether hydroquinone) and/or tocopherols. MEHQ is particularly preferred.

Tocopherol refers to compounds of the following formula: 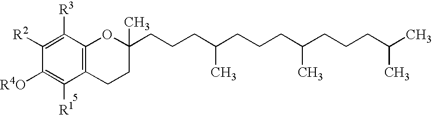
where R¹ is H or methyl R² is H or methyl R³ is H or methyl and R⁴ is H or acyl radical having 1-20 carbon atoms.

Preferred R⁴ radicals are acetyl, ascorbyl, succinyl, nicotinyl and other physiologically acceptable carboxylic acids. The carboxylic acids may be mono-, di- or tricarboxylic acids.

Preference is given to alpha-tocopherol where R1=R2=R3=methyl, especially racemic alpha-tocopherol. R4 is more preferably H or acetyl. RRR-alpha-Tocopherol is preferred in particular.

The half ethers of a hydroquinone are preferably added at 5-130 ppm, more preferably 30-70 ppm and especially at around 50 ppm to the monomer (a).

The water-absorbing polymers have been crosslinked, i.e., the polymerization is carried out in the presence of compounds having two or more polymerizable groups, preferably ethylenically unsaturated double bonds, which can be free-radically interpolymerized into the polymer network.

Useful monomers (b) (crosslinkers) include for example ethylene glycol dimethacrylate, diethylene glycol diacrylate, allyl methacrylate, trimethylolpropane triacrylate, triallylamine, tetraallyloxyethane, as described in EP-A 530 438, di- and triacrylates, as described in EP-A 547 847, EP-A 559 476, EP-A 632 068, WO 93/21237, WO 03/104299, WO 03/104300, WO 03/104301 and in German patent application 103 31 450.4, mixed acrylates which, as well as acrylate groups, comprise further ethylenically unsaturated groups, as described in German patent applications 103 31 456.3 and 103 55 401.7, or crosslinker mixtures, as described for example in DE-A 195 43 368, DE-A 196 46 484, WO 90/15830 and WO 02/32962.

Polymerizable groups are preferably selected from the group consisting of allyl (examples being allyl ether and allylamine groups), acryloyloxy and methacryloyloxy. Acryloyloxy and methacryloyloxy are particularly preferred. Acryloyloxy groups are most preferred. Crosslinkers may comprise two, three, four or more, preferably two, three or four and more preferably three or four polymerizable groups. Polymerizable groups in a crosslinker may be the same or different in that for example a crosslinker may comprise at least one acrylic ester group and at least one allyl ether group, at least one acrylic ester group and at least one allylamine group, at least one methacrylic ester group and at least one allyl ether group, at least one methacrylic ester groups and at least one allylamine group, at least two acrylic ester groups or at least two methacrylic ester groups, preferably at least one acryloyloxy group and more preferably at least two acryloyloxy groups.

Preferred crosslinkers are alkoxylated acrylic esters of trimethylolpropane and glycerol or mixtures thereof.

The production of a suitable base polymer is described in DE-A 199 41 423, EP-A 686 650, WO 01/45758 and WO 03/104300 as are further useful hydrophilic ethylenically unsaturated monomes and crosslinkers.

The acid groups of the hydrogels obtained have typically been partly neutralized, the degree of neutralization being preferably in the range from 25 to 85 mol %, more preferably in the range from 27 to 80 mol %, even more preferably in the range from 27 to 30 mol % or from 40 to 75%, and customary neutralizing agents may be used, preferably alkali metal hydroxides, alkali metal oxides, alkali metal carbonates or alkali metal bicarbonates and also mixtures thereof. Instead of alkali metal salts it is also possible to use ammonium salts. Sodium and potassium are particularly preferred as alkali metals, but very particular preference is given to sodium hydroxide, sodium carbonate or sodium bicarbonate and also mixtures thereof. Typically, neutralization is achieved by admixing the neutralizing agent as an aqueous solution or else preferably as a solid material.

Neutralization may be carried out after polymerization (at the hydrogel stage). But it is also possible to neutralize up to 40 mol %, preferably from 10 to 30 mol % and more preferably from 15 to 25 mol % of the acid groups prior to polymerization by adding a portion of the neutralizing agent to the monomer solution and setting the desired final degree of neutralization only after polymerization, at the hydrogel stage. The monomer solution may be neutralized by admixing with the neutralizing agent. The hydrogel may be mechanically comminuted, by a meat grinder for example, in which case the neutralizing agent may be sprayed, sprinkled or poured on and then carefully mixed in. To this end, the gel mass obtained may be repeatedly minced for homogenization. Neutralizing the monomer solution to the final degree of neutralization is preferred.

The neutralized hydrogel is then dried with a belt or drum dryer until the residual moisture content is preferably below 10% by weight and especially below 5% by weight, the moisture content being determined by the eponymous recommended test method No. 430.2-02 of EDANA (European Disposables and Nonwovens Association). The dried hydrogel is subsequently ground and sieved, useful grinding apparatus typically including roll mills, pin mills or swing mills. The particle size of the sieved, dried hydrogel is preferably below 1000 μm, more preferably below 850 μm and most preferably below 700 μm and preferably above 100 μm, more preferably above 150 μm and most preferably above 200 μm.

The base polymers are preferably then postcrosslinked. Useful postcrosslinkers include compounds comprising two or more groups capable of forming covalent bonds with carboxylate groups on the polymers. Useful compounds include for example alkoxysilyl compounds, polyaziridines, polyamines, polyamidoamines, di- or polyglycidyl compounds, as described in EP-A 083 022, EP-A 543 303 and EP-A 937 736, polyhydric alcohols, as described in DE-C 33 14 019, DE-C 35 23 617 and EP-A 450 922, or β-hydroxyalkylamides, as described in DE-A 102 04 938 and U.S. Pat. No. 6,239,230. It is further possible to use compounds of mixed functionality, such as glycidol, 3-ethyl-3-oxetanemethanol (trimethylolpropaneoxetane), as described in EP-A-1 199 327, aminoethanol, diethanolamine, triethanolamine or compounds which develop a further functionality after the first reaction, such as ethylene oxide, propylene oxide, isobutylene oxide, aziridine, azetidine or oxetane.

Useful postcrosslinkers v) are further said to include by DE-A 40 20 780 cyclic carbonates, by DE-A 198 07 502 2-oxazolidone and its derivatives, such as 2-hydroxyethyl-2-oxazolidone, by DE-A 198 07 992 bis- and poly-2-oxazolidinones, by DE-A 198 54 573 2-oxotetrahydro-1,3-oxazine and its derivatives, by DE-A 198 54 574 N-acyl-2-oxazolidones, by DE-A 102 04 937 cyclic ureas, by German patent application 103 34 584.1 bicyclic amide acetals, by EP-A-1 199 327 oxetanes and cyclic ureas and by WO 03/031482 morpholine-2,3-dione and its derivatives.

Postcrosslinking is typically carried out by spraying a solution of the postcrosslinker onto the hydrogel or onto the dry base-polymeric particles. After spraying the polymeric particles are thermally dried, and the postcrosslinking reaction may take place before but also during drying.

The spraying with the postcrosslinker solution is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers. Suitable mixers are for example Lödige® mixers, Bepex® mixers, Nauta® mixers, Processall® mixers and Schugi® mixers.

Contact dryers are preferable, shovel dryers are more preferable and disk dryers are most preferable as apparatus in which thermal drying is carried out. Suitable dryers are for example Bepex® dryers and Nara® dryers. Fluidized bed dryers can be used as well.

Drying may take place in the mixer itself, by heating the jacket or introducing a stream of warm air. It is similarly possible to use a downstream dryer, for example a tray dryer, a rotary tube oven or a heatable screw. But it is also possible for example to utilize an azeotropic distillation as a drying process.

It is particularly preferable to apply the postcrosslinker solution in a high speed mixer, for example of the Schugi-Flexomix® or Turbolizer® type, to the base polymer and for the latter to be thermally postcrosslinked in a reaction dryer, for example of the Nara-Paddle-Dryer® type or a disk dryer. The base polymer used can still have a temperature in the range from 10 to 120° C. from preceding operations, and the postcrosslinker solution can have a temperature in the range from 0 to 150° C. More particularly, the postcrosslinker solution can be heated to lower the viscosity. The preferred postcrosslinking and drying temperature range is from 30 to 220° C., especially from 150 to 210° C. and more preferably from 160 to 190° C. The preferred residence time in the reaction mixer or dryer at this temperature is below 100 minutes, more preferably below 70 minutes and most preferably below 40 minutes.

The copolymerization of the monomers of groups (a) and (b) may—if a change in the properties of the copolymers is desired—be carried out in the additional presence of monomers of group (c). Useful group (c) monomers include for example hydroxyethyl acrylate, hydroxypropyl acrylate, hydroxyethyl methacrylate, hydroxypropyl methacrylate, acrylonitrile and/or methacrylonitrile. Also useful are esters of acrylic acid and methacrylic acid with monohydric alcohols comprising from 1 to 18 carbon atoms, examples being methyl acrylate, ethyl acrylate, propyl acrylate, isopropyl acrylate, n-butyl acrylate, isobutyl acrylate, hexyl acrylate, 2-ethylhexyl acrylate, stearyl acrylate, the corresponding esters of methacrylic acid, diethyl fumarate, diethyl maleate, dimethyl maleate, dibutyl maleate, vinyl acetate and vinyl propionate. When monomers of group (c) are used for modifying the water-soluble addition polymers, these are used in general at less than 50 mol % preferably from 0.5 to 20 mol % and in particular from 2 to 10 mol % based on the monomers (a).

The water-soluble polymers, if used in the copolymerization, may be finely dispersed in the aqueous dispersion by means of emulsifiers. Useful emulsifiers include for example ethoxylated nonylphenols, ethoxylated castor oil, alkyl sulfates, sorbitan fatty esters, ethoxylated sorbitols, ethoxylated sorbitan fatty esters and alkylsulfonates. Emulsifiers are used in an amount from 0% to 3% by weight based on the monomers (a).

The polymerization may if appropriate be carried out in the presence of customary polymerization regulators. Useful polymerization regulators include for example thio compounds, such as thioglycolic acid, mercapto alcohols, examples being 2-mercaptoethanol, mercaptopropanol and mercaptobutanol, dodecyl mercaptan, formic acid, ammonia and amines, examples being ethanolamine, diethanolamine, triethanolamine, triethylamine, morpholine and piperidine.

The monomers (a), (b) and if appropriate (c) are copolymerized with each or one another in from 20% to 80%, preferably from 20% to 50% and especially from 30% to 45% by weight aqueous solution in the presence of polymerization initiators. Useful polymerization initiators include all compounds which cleave into free radicals under the polymerization conditions, examples being peroxides, hydroperoxides, hydrogen peroxide, persulfates, azo compounds and redox catalysts. Preference is given to using water-soluble catalysts. It is preferable in some cases to use mixtures of various polymerization initiators, examples being mixtures of hydrogen peroxide and sodium peroxodisulfate or potassium peroxodisulfate. Mixtures of hydrogen peroxide and sodium peroxodisulfate can be used in any desired proportion. Useful organic peroxides include for example acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, tert-butyl per-3,5,5-trimethylhexanoate and tert-amyl perneodecanoate. Useful polymerization initiators further include azo initiators, examples being 2,2′-azobis (2-amidinopropane) dihydrochloride, 2,2′-azobis (N, N-dimethylene)isobutyramidine dihydrochloride, 2- (carbamoylazo)isobutyronitrile and 4,4′-azobis (4-cyanovaleric acid). The identified polymerization initiators are used in customary amounts, for example in amounts from 0.01 to 5 and preferably from 0.1 to 2 mol %, based on the monomers to be polymerized.

In redox catalysts, the oxidizing component comprises at least one of the per compounds indicated above and the reducing component comprises for example ascorbic acid, glucose, sorbose, ammonium bisulfite, ammonium sulfite, ammonium thiosulfate, ammonium hyposulfite, ammonium pyrosulfite, ammonium sulfide, alkali metal bisulfite, alkali metal sulfite, alkali metal thiosulfate, alkali metal hyposulfite, alkali metal pyrosulfite, alkali metal sulfide, metal salts, such as iron (II) ions or silver ions or sodium hydroxymethylsulfoxylate. The reducing component in a redox catalyst is preferably ascorbic acid or sodium pyrosulfite. Based on the amount of monomers used in the polymerization, from 1×10⁻⁵ to 1 mol % is used of the reducing component of the redox catalyst system and from 1×10⁻⁵ to 5 mol % of the oxidizing component of the redox catalyst. Instead of or in addition to the oxidizing component of the redox catalyst it is also possible to use one or more water-soluble azo initiators.

The process of the present invention is preferably carried out using a redox system consisting of hydrogen peroxide, sodium peroxodisulfate and ascorbic acid. In a typical embodiment, these components are used in the concentrations of 1×10⁻² mol % of hydrogen peroxide, 0.084 mol % of sodium peroxodisulfate and 2.5×10⁻³ mol % of ascorbic acid based on the monomers.

The aqueous monomer solution may comprise the initiator in solution or dispersion. However, the initiators may also be fed into the mixing kneader separately from the monomer solution.

Prior to polymerization, the monomer solution is freed of residual oxygen. This is accomplished by means of an inert gas, which may be introduced in concurrent, in countercurrent or at entry angles in between. Good mixing may be obtained for example using nozzles, static or dynamic mixers or bubble columns.

The monomer solution is likewise passed through the reactor with an inert gas stream. The mass throughput in terms of monomer solution is preferably not less than 500, more preferably not less than 1000, even more preferably not less than 2000 and especially not less than 3000 kg/hm³ (reactor volume) with the inert gas stream preferably being not less than 100 l/hm³ (reactor volume).

The inert gases used may be, independently, water vapor, nitrogen, a noble gas such as argon, carbon monoxide, carbon dioxide, sulfur hexafluoride or a mixture thereof. The inert gas may be wholly or partly generated by a chemical reaction in the mixing kneader. Preference is given to using water vapor, carbon dioxide and/or nitrogen as inert gas.

The reactor volume may vary according to the desired conversion. The reactor volume is preferably not less than 0.5 m³ more preferably at least 0.7 m³, even more preferably in the range from 1 to 25 m³ and especially in the range from 3 to 12 m³. At the point of addition of the monomers into the mixer the materials are liquid, but the consistency of the reaction mixture changes via a highly viscous state into a crumbly gel which is discharged at the downstream end of the mixer by the continuous conveying action of the mixer. The gel produced by the polymerization is comminuted into a finely divided, crumbly gel in the mixer and is then discharged in that state. Preferably, some of the water is removed during the polymerization in the mixer, so that the crumbly particles of gel obtained at the downstream end of the mixture have a solids content in the range from 20% to 100% by weight.

The fill level in the kneader is measured in the region of crumbly gel. According to the present invention, the region of crumbly gel is defined as starting from that point in the kneader volume at which no fewer than 50 gel particles per liter of reactor volume are present.

The fill level is computed as the quotient of (mass of polymer gel particles/bulk density)/region in kneader with crumbly gel.

The fill level is not less than 71% and preferably not more than 99% and more preferably is in the range between 73% and 95% and even more preferably in the range between 75% and 90% and especially in the range from 80% to 85%.

Polymerization zone in the kneader is to be understood as referring to that zone in which up to 70% of the conversion of the polymerization takes place. Conversion can be measured by determining the residual monomer content of the gel. The largest part of the polymerization takes place in the first quarter of the kneader. The temperature-measuring location for measuring the temperature and temperature fluctuations in the polymerization zone is situated in the walls of the kneader. Suitable positions for temperature measurement are at a distance of 5% to 6% of the reactor length in the product discharge direction from the monomer-metering location. When the monomer is added at 4% of the reactor length for example, suitable locations will be at 9% to 10% of the reactor length. Reactor length refers to the length of the inner space of the reactor. Temperature fluctuation refers to the difference between the maximum and minimum temperatures at the measuring location within an hour.

We have found that, surprisingly, fewer agglomerates occur in a kneader equipped with backmixing when the temperature in the polymerization zone is more than 65° C., preferably more than 70° C., more preferably more than 75° C., even more preferably more than 80° C. and especially more than 85° C. The upper limit of the temperature in the polymerization zone is generally at 100° C., preferably at 96° C. In a particularly preferred embodiment, the temperature fluctuations per hour are below 20° C., preferably 15° C., more preferably 10° C., especially 5° C.

There are two parameters relating to residence time behavior which are very important for the quality of the product produced in continuous kneading reactors, namely the average residence time in the reactor of the raw materials to be reacted and the width of the residence time distribution.

The residence time of a material indicates how long the material dwells in the reactor from the time it is fed into the reactor to the time it leaves the reactor. Residence time is influenced for example by the internal volume of the reactor, the rate of reactant feed and the fill level. The usual commercial strategy is to minimize the residence time to optimize the space-time yield.

Since not all particles have the same residence time, the result is a so-called residence time distribution width. It can be influenced for example through the design of the kneader shafts in that the shafts' geometry will create a more or less pronounced backward or forward transportation for the material. In effect, material to be reacted is transported in the forward direction by a stirrer shaft to which stirring paddles and kneading hooks are attached. At the same time, however, the gel is being transported in the backward direction as a result of some of the paddles being attached in the kneader such that the stream of material being transported goes in the opposite direction.

The degree of backmixing may further be influenced via variation of the fill height (weir at kneader outlet) and also metering rate at kneader inlet or at various locations in the kneader (various possible additives) and also changes in the speed of rotation of the stirring shafts and specific back-conveying zones.

When a broad residence time distribution is preferred for reasons of quality, for example in order to smooth out quality fluctuations in the material produced, kneaders having a broad residence time distribution will typically be chosen.

However, we have found that, surprisingly, superior polymers are obtained with kneaders having a backmixing ratio of less than 0.33. Preference is given to a backmixing ratio of less than 0.3, more preferably less than 0.27, even more preferably less than 0.26 or even less than 0.25, especially less than 0.24. The backmixing ratio is the quotient of residence time distribution and mean residence time.

The backmixing ratio may be measured by adding and measuring the residence time characteristics of a tracer. The backmixing ratio is equal to (A+B)/2C where

C is the period from the start of the addition of the tracer to the attainment of the 50% value of the accumulated tracer quantity at the kneader outlet,

A is the period for the tracer quantity at the kneader outlet to rise from 5% to 95% of the maximum value, and

B is the period for the tracer quantity at the kneader outlet to fall from 95% to 5% of the maximum value.

The temperature and the temperature fluctuation can be brought into the present invention's range by a high fill level of at least 71% or else by metered addition of fine particles of the polymer. Fine particles refers to particles of the polymerization product which if appropriate are surface postcrosslinked and have an average particle size below 300 μm, preferably below 250 μm and especially below 200 μm. The fine particles generally have a water content below 30% by weight and preferably below 20% by weight. The fine particles are generally added after 90% polymerization conversion, preferably after 95%, more preferably after 99% and especially after 99.5% conversion. The amount of fine particles added is typically between 5% and 30% by weight and preferably between 10% and 20% by weight based on dry polymer (without fine particles). The fine particles can also be added at a plurality of locations in the kneader.

Preference is given to kneaders equipped with two or more axially parallel rotating shafts fitted with a plurality of kneading and transporting elements.

Mixing kneaders useful in the process of the present invention are obtainable from List and are described for example in CH-A 664 704, EP-A 517 068, WO 97/12666, DE-A 21 23 956, EP-A 603 525, DE-A 195 36 944 and DE-A 41 18 884.

Such kneaders with 2 shafts have by virtue of the arrangement of the kneading and transporting elements a high self-cleaning effect which is an important requirement for a continuous polymerization. The two shafts preferably contrarotate.

The stirring shaft is fitted with disk segments in propeller fashion. Useful kneading and transporting elements include for example close-clearance mixing bars and L- or U-shaped attachments.

The reaction may also be carried under reduced pressure at 100-800 mbar and especially in the range from 200 to 600 mbar.

The mixing kneader may be heated or cooled as required. The monomer solution is polymerized therein at a temperature in the range from −10° C. and preferably 0° C. to 140° C. and preferably 100° C. The temperature is preferably in the range from 30 to 120° C. and especially the maximum temperature is in the range from 50 to 100° C., more preferably not more than 95° C. and especially not more than 90° C.

The process of the present invention is preferably carried out such that the fraction of heat removed by evaporation of water from the reaction mixture is not less than 5%, preferably not less than 15% and more preferably not less than 25% of the heat of reaction.

Preference is further given to versions of the process where the fraction of heat removed by product discharge is not less than 25%, preferably not less than 45% and especially not less than 55% of the heat of reaction.

Preference is given to processes wherein in total not less than 50%, more preferably not less than 70% and especially not less than 90% of the heat of reaction is removed by product discharge and water evaporation.

In a very particularly preferred version of the process, the inner surface of the reactor and/or one or more, preferably all, shafts are cooled.

The as-polymerized gel has a water content in the range from 0% to 80% by weight and preferably in the range from 40% to 70% by weight. This relatively low moisture content for an already free-flowing gel which does not clump reduces the energy subsequently required for drying.

The as-polymerized gel preferably has a residual monomer content of below 170 ppm, preferably 160 ppm or less. Even values of 150 ppm or less, 120 ppm or less and even 100 ppm or less can be achieved with the process of the present invention.

The production process is notable for short residence times in the reactor and hence for a good space-time yield. Even residence times of below 30 minutes in a reactor volume of not less than 500 l gives fine particles of addition polymer gel having a very low residual monomer content. This does away with the need for the otherwise required costly and inconvenient separation processes and increases the yield. Particular preference is given to versions of the process which involve a high mass throughput which permits residence times of below 20 minutes and even below 10 minutes.

The time to peak temperature in the process of the present invention is preferably 5 minutes or less and more preferably in the range from 2 to 4 minutes. This range locates the optimum with regard to throughput in the reactor and product quality (few agglomerates, good residual monomer values, etc.).

The polymer gel leaving the reactor may subsequently be stored in a delay vessel at temperatures in the range from 50 to 120° C. and preferably in the range from 80 to 100° C. The delay time is generally in the range from 3 minutes to 3 hours and preferably in the range from 5 to 30 minutes. The vessel can be open at the top, but it is also possible to use a closed vessel to which a slight vacuum or slight overpressure is applied.

The drying step can be carried out according to all known processes, for example in a fluidized bed, on a through circulation drying belt, on a vacuum drying belt or with the aid of microwave drying, or preferably under reduced pressure in a single-screw kneader with intensive kneading through of the polymer gel. This drying step is preferably carried out in a single-or multi-screw kneader at a pressure in the range from 5 to 300, and preferably from 20 to 70 mbar and temperatures in the range from 30 to 170 C. Drying affords a free-flowing polymeric gel which has a very high water uptake and can be used as a soil improver or as an absorbent in hygiene articles, for example diapers. Parts and percentages in the examples are by weight.

### Description of Test Methods

Centrifuge retention capacity is determined by the eponymous recommended test method No. 441.2-02 of EDANA (European Disposables and Nonwovens Association).

To determine centrifuge retention capacity, 0.2000±0.0050 g of dried water-absorbing polymer (particle size fraction from 106 to 850 μm) was weighed into a teabag 60×85 mm in size, which was subsequently sealed. The teabag was then placed for 30 minutes in an excess of 0.9% by weight sodium chloride solution or 10% by weight aqueous solution of an alkali metal salt of a nonpolymeric carboxylic acid (not less than 0.83 l of solution/1 g of polymeric powder). The teabag was subsequently centrifuged at 250 G for 3 minutes. The centrifuged teabag was weighed to determine the amount of liquid retained by the water-absorbing polymer.

The determination of the residual monomers was carried out according to the eponymous recommended test method ERT No. 410.2-02 of EDANA (European Disposables and Nonwovens Association).

The peak temperature was measured as time difference between initiator addition and maximum temperature in resultant gel.

Absorbency under load AUL 0.7 psi (4826.5 Pa)

The measuring cell for determining AUL 0.7 psi (4826.5 Pa) is a Plexiglas cylinder 60 mm in internal diameter and 50 mm in height. Adhesively attached to its underside is a stainless steel sieve bottom having a mesh size of 36 mm. The measuring cell further includes a plastic plate 59 mm in diameter and a weight which can be placed in the measuring cell together with the plastic plate. The weight of the plastic plate and of the weight totals 1345 g. To determine AUL 0.7 psi (4826.5 Pa) the weight of the empty Plexiglas cylinder and of the plastic plate is measured and recorded as Wₒ. 0.900±0.005 g of hydrogel-molding polymer (particle size distribution: 150-800 μm) is weighed into the Plexiglas cylinder and distributed as uniformly as possible over the stainless steel sieve bottom. The Plexiglas plate is then carefully placed in the Plexiglas cylinder, the entire unit is weighed and the weight is recorded as Wₐ. Then the weight is placed on the plastic plate in the Plexiglas cylinder. A ceramic filter plate 120 mm in diameter and 0 in porosity is placed in the center of a Petri dish 200 mm in diameter and 30 mm in height and sufficient 0.9% by weight sodium chloride solution is introduced for the surface of the liquid to be level with the filter plate surface without the surface of the filter plate being covered. Then a round filter paper 90 mm in diameter and <20 mm in pore size (Schwarzband 589 from Schleicher & Schüll) is placed on the ceramic filter plate. The Plexiglas cylinder comprising hydrogel-molding polymer is then placed together with the plastic plate and weight on top of the filter paper left there for 60 minutes. At the end of this period, the complete unit is removed from the filter paper and the Petri dish and subsequently the weight is removed from the Plexiglas cylinder. The Plexiglas cylinder comprising swollen hydrogel is weighed together with the plastic plate and the weight is recorded as W_{b}. AUL 0.7 psi (4826.5 Pa) is calculated according to the following equation:
AUL 0.7 psi=[W_{b}−Wₐ]/[Wₐ−Wₒ]

AUL (40 g/cm²) can be measured in a similar manner by applying lower weights.

### Prescription For Bulk Density Measurement of Moist Superabsorbent Gel

A 1 liter glass beaker is tared on a laboratory scale (measuring range 5 kg).

The glass beaker is then filled with still warm fresh gel particles directly after polymerization up to the 1 liter mark loosely without compacting the particles, for which the cone of repose has to be leveled down by displacing to the sides. In the process, gel pieces >5 cm in diameter are sorted out. The measurement is to be carried out speedily within 5 minutes in order that distortion due to water evaporation may be avoided. When carrying out the entire measurement it should be ensured that the gel is not subjected to any pressure from above, in order to prevent compacting of the gel particles.

The bulk density of the gel is then obtained by renewed weighing of the filled glass beaker according to the formula below, in grams per liter [g/l].
Bulk density=(glass beaker with gel in g)−(glass beaker empty in g)

### Measuring Backmixing On Using A Continuous Kneader For Polymerization In Production of Superabsorbents

Residence time and residence time distribution width and hence the backmixing properties can be determined through fairly simple experiments:

Suitable markers are added at the upstream end of the kneader according to the principle of an on/off switch during ongoing continuous operation over a certain period, for example an hour. A dye can be used in the simplest case, but for example aqueous potassium hydroxide solution or a solution of calcium chloride, of aluminum sulfate or of potassium sulfate is preferred, since they have essentially no influence on the quality of the end product when superabsorbents are produced. It is then relatively simple to analytically determine the varying level of the added material at the kneader outlet by sampling at suitable time intervals and analysis thereof. Aluminum sulfate solution may be used here as an example.

After a continuous metered addition of aluminum sulfate solution at the kneader inlet has been switched on, the time is taken. It takes a while until aluminum can be detected at the kneader outlet. The aluminum content increases and the aluminum content approaches a limit. This limit, resulting from the amount of aluminum sulfate solution added per unit time based on all additions into the kneading reactor minus any losses due to vaporization or evaporation, is 100% (=maximum amount of aluminum concentration in effluent).

The mean residence time is then obtained from the time span between the switching on of the marker addition and the time when the aluminum concentration has reached 50% of the theoretical final value.

The residence time distribution width is obtained from the rising and falling flank of the tracer concentration.

When determining the residence time distribution width it must be borne in mind that theoretically the theoretical final value (100% or 0%) can never be achieved. Therefore the present invention provides that the residence time distribution width is approximated from the time span from the first detection of the marker (aluminum for example) at the outlet (5% of the theoretically attainable amount) to the time when 95% of the theoretically attainable final value is reached (=“duration of rise”). This time increases with the degree to which a kneader has been designed for backmixing.

The situation for the switching off of the metered addition is similar. After a certain time at which the tracer content is stable it falls. The time from the start of the fall of the tracer concentration (95%) to the time at which the concentration has fallen to 5% of the original value (=“duration of fall”) is relevant here.

A good measure of the backmixing of the kneader can be expressed through the quotient as a backmixing ratio:

start of tracer addition:

backmixing A=duration of rise/residence time in kneader

or

end of tracer addition:

backmixing B=duration of fall/residence time in kneader

the present invention provides that the average value of the two determinations is used.

The examples which follow illustrate the invention.

### EXAMPLE 1

### Composition of Reaction Solution Used

A 39% by weight acrylic acid/sodium acrylate solution is prepared with a 75 mol % degree of neutralization by continuous mixing of deionized water, caustic soda (50% by weight) and acrylic acid. The acrylic acid used complies with the following specification: not less than 99.5% by weight of acrylic acid, not more than 0.1% by weight of water, not more than 500 ppm of diacrylic acid, 200 ppm of hydroquinone monomethyl ether (MEHQ), <2000 ppm of acetic acid, <600 ppm of propionic acid). After the mixing of the components, the monomer solution is continuously cooled down to a temperature of 20° C. by a heat exchanger and stripped of oxygen with nitrogen.

The free-radical polymerization was initiated using the following solutions: 0.08% by weight of hydrogen peroxide and 15% by weight of sodium peroxodisulfate in water and also 1% of ascorbic acid in water.

The polyethylenically unsaturated crosslinker used is polyethylene glycol 400 diacrylate (Cray Valley) in an amount of 0.45% by weight based on the monomers—expressed as acrylic acid—present in the reaction solution.

The individual components are continuously metered into a 6.3 m³ capacity List Contikneter continuous kneader reactor from List of Arisdorf in Switzerland at the following rates:

| | | |
|---|---|---|
| 18 | metric tons/h | of monomer solution |
| 81 | kg/h | of polyethylene glycol 400 diacrylate |
| 15 | kg/h | of hydrogen peroxide solution/sodium peroxodisulfate |
| 5 | kg/h | of ascorbic acid solution |

The reaction solution had a temperature of 23.5° C. on addition. The reactor is operated at a speed for the shafts of 38 rpm. The polymerization proceeds relatively recalcitrantly and if appropriate has to be restarted by raising the amount of initiator. The residence time for the reaction mixture in the reactor was 15 min.

The product obtained was tacky and comprised an elevated fraction of agglomerates. Agglomerates are coarse particles of gel >5 cm in size (diameter). The agglomerate fraction was more than 200 agglomerates (>5 cm)/h. The fraction of agglomerates >10 mm was about 0.9 metric ton/h based on dry agglomerates. A residual acrylic acid content of 12.3% by weight and a solids content of 41.0% by weight were found by analysis in the product gel obtained. The gel was dried, ground and standardized to a particle size fraction of 100-850 μm by sieving. The dried polymer had a residual monomer content of 6000 ppm, a water content of 4.5% and a centrifuge retention of 37.6 g/g. The pH of the polymer was 6.1.

The polymer is surface postcrosslinked using a solution of 15% by weight of ethylene glycol diglycidyl ether dissolved in a mixture of 33% by weight of 1,2-propylene glycol and 67% by weight of water. The superabsorbent is subsequently surface treated continuously as a powder (7000 kg/h) in a Schugi-Flexomix with 210 kg/h. The spraying with crosslinker solution is followed by a thermal treatment step in a downstream dryer at a temperature of 150° C. for a period of 60 minutes.

The polymer thus obtained has an AUL (0.7psi)=15.4 g/g and a CRC=31.6 g/g.

### EXAMPLE 2

Example 1 is repeated except that in the present case the amount of initiator solution metered in was raised to 70.8 kg/h and the amount of ascorbic acid was raised to 20 kg/h. The polymerization started speedily even in the course of the initiator solution still being mixed in.

The crumbly product obtained had a slightly reduced agglomerates fraction of about 120 agglomerates (>5 cm)/h. The fraction of agglomerates >10 mm was about 0.4 metric tons/h based on dry agglomerates. The gel was dried, ground and a particle size fraction of 100-850 μm was obtained by sieving. The dried polymer had a residual monomer content of 350 ppm and a centrifuge retention capacity of 38.8 g/g. The pH of the polymer, was 6.1.

The polymer thus obtained was subjected to a surface-postcrosslinking operation as described in Example 1. The polymer thus obtained has AUL (0.7 psi)=18.2 g/g and CRC=30.6 g/g.

### EXAMPLE 3

Example 1 was repeated except that the acrylic acid used in the present case had a specification of 120 ppm of MEHQ. The polymerization was initiated by metered addition as in Example 1 of 15.5 kg/h of initiator solution. The peak temperature was reached in 3 minutes.

The product obtained was a finely divided, crumbly hydrogel which was virtually free of any agglomerates. The gel was dried, ground and standardized to a particle size distribution of 100-800 μm. The dried polymer had a residual monomer content of 150 ppm and also a centrifuge retention capacity of 37.6 g/g. The pH of the polymer was 6.l.

The polymer thus obtained was subjected to a surface-postcrosslinking operation as described in Example 1. The polymer thus obtained has AUL (0.7 psi)=24.0 g/g and CRC=29.8 g/g.

### EXAMPLE 4

Example 1 was repeated except that the acrylic acid used in the present case had a specification of 50 ppm of MEHQ. The polymerization was initiated by metered addition as in Example 1 of 15.5 kg/h of initiator solution.

The product obtained was a finely divided, crumbly hydrogel which was virtually free of any agglomerates. The gel was dried, ground and standardized to a particle size distribution of 100-800 μm. The dried polymer had a residual monomer content of 160 ppm and also a centrifuge retention capacity of 36.9 g/g. The pH of the polymer was 6.l.

The polymer thus obtained was subjected to a surface-postcrosslinking operation as described in Example 1. The polymer thus obtained has AUL (0.7 psi)=25.3 g/g and CRC=30.9 g/g.

### EXAMPLE 5

A 38.8% by weight acrylic acid/sodium acrylate solution is prepared with a 71.3 mol % degree of neutralization by continuous mixing of water, caustic soda (50% by weight) and acrylic acid. After the mixing of the components, the monomer solution is continuously cooled down to a temperature of 20° C. by a heat exchanger and devolatilized with nitrogen.

The free-radical polymerization was initiated using the following solutions: 0.08% by weight of hydrogen peroxide and 15% by weight of sodium peroxodisulfate in water and also 1% of ascorbic acid in water.

The polyethylenically unsaturated crosslinker used is 0.8% by weight polyethylene glycol 400 diacrylate (Cray Valley) based on the monomers present in the reaction solution.

The individual components are continuously metered into a 6.3 m³ capacity List Contikneter reactor from List of Arisdorf in Switzerland at the following rates:

| | | |
|---|---|---|
| 18 | metric tons/h | of monomer solution |
| 55.8 | kg/h | of polyethylene glycol 400 diacrylate |
| 55.8 | kg/h | of hydrogen peroxide/sodium peroxodisulfate |
| | | solution |
| 18.9 | kg/h | of ascorbic acid solution |

The reaction solution had a temperature of 29° C. on addition. The reactor is operated at a speed for the shafts of 38 rpm. 300 mm away from the point of addition of the raw materials in the direction of the reactor outlet, the reactor has a temperature-measuring site (corresponding to 660 mm distance from the front wall of the reactor). At this site, the temperature is monitored as a function of time. During the polymerization, fine superabsorbent <200 μm in particle size is additionally added into the reactor at an 800 kg/h rate to the polymer (at a conversion >99%). The residence time for the reaction mixture in the reactor was 15 min.

The reactor fill level is adjusted, during operation, by means of an opening (a weir) situated on the side in the rear portion of the reactor. The gel discharge area (fully opened: 660mm×400mm 0.264m²)) is opened to the dimensions 420mm×400mm (0.168m²). As a result, the reactor fill level adjusts to 60% of maximum.

The temperature observed at the abovementioned temperature-measuring location varies over hours in a range of 70° C.-100° C.

With this setting, the reactor effluent is found to include about 0.75 metric tons/h of gel particles (based on dry weight) >10 mm in diameter. The fraction of agglomerates was about 8 agglomerates (>5 cm)/h.

On drying, grinding and sieving of gel particle <10 mm in size and after adjustment of the particle size distribution to 100 μm-850 μm a centrifuge retention of 38.1 g/g is obtained.

The base polymer thus obtained is subsequently subjected to a surface-postcrosslinking operation as described in Example 1.

The quality of the product thus obtained can be gauged from the sum total of CRC+AUL (40 g/cm³). The following values result for the product obtained here:

CRC=30.7 g/g

AUL (40 g/cm³)=26.1 g/g

=>CRC+AUL (40 g/cm³)=56.8 g/g

### EXAMPLE 6

Example 5 was repeated except that the weir on the reactor was closed to an area of 180mm×400 mm (0.072 m²). This raises the fill level in the reactor to about 85% of maximum. With this setting, the fraction of moist particles >5 mm in diameter reduces to below 0.1 metric tons/h. The temperature measured at the temperature-measuring location in the reactor was over hours fairly constant in the range of 85° C.-100° C.

On drying, grinding and sieving of gel particle <10 mm in size and after adjustment of the particle size distribution to 100 μm-850μm a centrifuge retention of 38.4 g/g is obtained.

Surface postcrosslinking this polymer similarly to Example 1 resulted in the following absorptive data:

CRC=31.3 g/g

AUL (40 g/cm³)=30.0 g/g

=>CRC+AUL (40 g/cm³)=61.3 g/g

### EXAMPLE 7

Example 6 was repeated except that no superabsorbent fines were added to the polymer gel.

It was determined that the fill level in the reactor decreased to 80% as a result and the temperature measured at the temperature-measuring location in the reactor varied over hours in a range of 70° C.-100° C. The fraction of moist particles having a diameter >5 mm was 0.2 metric tons/h.

The base polymer thus obtained had a CRC value of 37.8 g/g.

Surface postcrosslinking this polymer similarly to Example 1 resulted in the following absorptive data:

CRC=29.6 g/g

AUL (40 g/cm³)=28.4 g/g

=>CRC+AUL (40 g/cm³)=58.0 g/g

### EXAMPLE 8

Example 5 was repeated except that no superabsorbent fines were added.

It was determined that the fill level in the reactor decreased to 55% as a result and the temperature measured at the temperature-measuring location in the reactor varied over hours in a range of 50° C.-100° C.

With this setting, the reactor effluent was found to include 0.85 metric tons/h of gel particles having a diameter >10 mm. The fraction of agglomerates was more than 50 agglomerates (>5 cm)/h. The base polymer obtained after drying, grinding and sieving had a CRC value of 37.4 g/g.

Surface postcrosslinking this polymer similarly to Example 1 resulted in the following absorptive data:

CRC=29.5 g/g

AUL (40 g/cm³)=25.4 g/g

=>CRC+AUL (40 g/cm³)=54.9 g/g

### EXAMPLE 9

Example 5 is repeated.

After the continuous polymerization in the kneader has been started up and run stably for at least 1 hour, a metered addition is commenced of 1% aluminum sulfate solution in deionized water at the inlet of the kneading reactor.

About 200 g gel samples are drawn at the outlet of the kneader every 15 seconds. They are dried at 180° C. and ground. The aluminum content of these samples is determined by analysis and plotted as a percentage of the maximum possible content against time. The following results are determined:

start of metered addition:

time from start to attainment of 50% value: 15.0 min

time of rise from 5% to 95% of aluminum content: 4.0 min

termination of metered addition:

time from termination to attainment of 50% value: 15.0 min

time of drop from 95% to 5% of aluminum content: 4.0 min

$$⇒ A / C = \frac{4.0 min}{15.0 min} = 0.267 \\ ⇒ B / C = \frac{4.0 min}{15.0 min} = 0.267$$

The backmixing ratio in this case is (A+B)/2C=0.267

### EXAMPLE 10

Example 5 is repeated except that the speed of the kneader shafts is raised to 45 rpm. Since, as a result, the transporting performance of the kneader shafts increases or decreases to a certain extent depending on the design of the kneading hooks attached thereto (depending on the fraction of forwardly or backwardly conveying kneading hooks), the fill level in the kneading reactor is kept constant at 60% by readjusting the weir opening at the kneader outlet.

After the continuous polymerization in the kneader has been started up and run stably for at least 1 hour, a metered addition is commenced of 1% aluminum sulfate solution in deionized water at the inlet of the kneading reactor.

About 200 g gel samples are drawn at the outlet of the kneader every 15 seconds. They are dried at 180° C. and ground. The aluminum content of these samples is determined by analysis and plotted as a percentage of the maximum possible content against time. The following results are determined:

start of metered addition:

time from start to attainment of 50% value: 15.0 min

time of rise from 5% to 95% of aluminum content: 5.25 min

termination of metered addition:

time from termination to attainment of 50% value: 15.0 min

time of drop from 95% to 5% of aluminum content: 5.5 min

$$⇒ A / C = \frac{5.25 min}{15.0 min} = 0.350 \\ ⇒ B / C = \frac{5.5 min}{15.0 min} = 0.367$$

The backmixing ratio in this case is (A+B)/2C=0.359

The superabsorbents thus obtained are worked up and also surface-postcrosslinked as described in Example 5 to yield a granular product having the following properties:

AUL (40 g/cm²)=24.7 g/g

CRC=30.5 g/g

=>CRC+AUL=55.2 g/g

### EXAMPLE 11

Example 5 is repeated except that the speed of the kneader shafts is lowered to 33 rpm. Since, as a result, the transporting performance of the kneader shafts increases or decreases to a certain extent depending on the design of the kneading hooks attached thereto (depending on the fraction of forwardly or backwardly conveying kneading hooks), the fill level in the kneading reactor is kept constant at 60% by readjusting the weir opening at the kneader outlet.

After the continuous polymerization in the kneader has been started up and run stably for at least 1 hour, a metered addition is commenced of 1% aluminum sulfate solution in deionized water at the inlet of the kneading reactor.

About 200 g gel samples are drawn at the outlet of the kneader every 15 seconds. They are dried at 180° C. and ground. The aluminum content of these samples is determined by analysis and plotted as a percentage of the maximum possible content against time. The following results are determined:

start of metered addition:

time from start to attainment of 50% value: 15.0 min

time of rise from 5% to 95% of aluminum content: 3.50 min

termination of metered addition:

time from termination to attainment of 50% value: 15.0 min

time of drop from 95% to 5% of aluminum content: 3.75 min

$$⇒ A / C = \frac{3.50 min}{15.0 min} = 0.233 \\ ⇒ B / C = \frac{3.75 min}{15.0 min} = 0.250$$

The backmixing ratio in this case is (A+B)/2C=0.242

The superabsorbents thus obtained are worked up and also surface-postcrosslinked as described in Example 5 to yield a granular product having the following properties:

AUL (40 g/cm²)=26.3 g/g

CRC=30.8 g/g

=>CRC+AUL=57.1 g/g

Examples 9 to 11 above reveal that product quality deteriorates with increasing backmixing (increasing backmixing ratio) in that the CRC+AUL quality parameter decreases.

1. A process for continuous production of crosslinked fine particles of an addition-polymer gel by copolymerizing
a) water-soluble monoethylenically unsaturated monomers,
b) from 0.001 to 5 mol % based on the monomers (a) of monomers comprising at least two polymerizable groups,
in a mixing kneader which conveys materials introduced at an upstream end of the kneader in an axial direction toward a downstream end of the kneader, wherein at least one of the following conditions is fulfilled:
i) fill level in the mixing kneader is not less than 71%,
ii) the water-soluble monoethylenically unsaturated monomers comprise up to 150 ppm of a half-ether of a hydroquinone,
iii) a temperature measured at a temperature-measuring location in the kneader walls at a distance of 5% to 6% of the length of the internal space of a reactor of the kneader in a product discharge direction from a monomer-metering location is more than 65° C.,
iv) the kneader has a backmixing ratio of less than 0.33.

2. The process according to claim 1 wherein the kneader is equipped with two or more axially parallel rotating shafts equipped with a plurality of kneading and transporting elements.

3. The process according to claim 1 wherein at least one of the following conditions is fulfilled:
i) the fill level in the kneader is between 73% and 95%,
ii) the water-soluble monoethylenically unsaturated monomers comprise between 5 and 130 ppm of a half-ether of a hydroquinone,
iii) the temperature at the temperature-measuring location is more than 70° C.,
iv) the kneader has a backmixing ratio of less than 0.27.

4. The process according to claim 1 wherein the kneader volume is not less than 0.5 m³.

5. The process according to claim 1 wherein the mass throughput of water-soluble monoethylenically unsaturated monomers is not less than 500 kg/h.

6. The process according to claim 1 wherein the copolymerization is carried out under an inert gas, the inert gas comprising at least one gas selected from water vapor, carbon dioxide, and nitrogen.

7. The process according to claim 1 wherein the copolymerization is carried out under a pressure of 100-800 mbar.

8. The process according to claim 1 wherein a maximum temperature during the polymerization is between 50° C. and 100° C.

9. The process according to claim 1 wherein a fraction of heat removed by evaporation of water from the reaction mixture is not less than 5% of the heat of reaction and a fraction of heat removed by product discharge is not less than 25% of the heat of reaction.

10. The process according to claim 1 wherein the inner surface of the reactor of the kneader and/or at least one shaft are cooled.

11. The process according to claim 2 wherein the shafts of the kneader contrarotate.

12. The process according to claim 1 wherein the monomers a) are selected from the group consisting of acrylic acid, methacrylic acid, an alkali metal or ammonium salt of these acids, acrylamide, and/or methacrylamide.

13. The process according to claim 1 wherein the monomers b) comprise 3 or more ethylenically unsaturated double bonds and/or are (meth)acrylic esters.

14. The process according to claim 1 wherein the half-ether of a hydroquinone is MEHQ or a tocopherol.

15. The process according to claim 1 wherein the residual monomer content of the resulting crosslinked fine particles of addition-polymer gel is below 170 ppm.

16. The process according to claim 1 wherein a peak temperature is attained in less than 5 minutes.

17. The process according claim 1 wherein the crosslinked, finely divided addition polymer in gel form is aftertreated comprising at least one of the steps of drying, grinding, sieving, surface postcrosslinking, and surface treatment.
